(19) United States
(12) Patent Application Publication
(10) Pub. No.: US 2003/0198349 A1
(43) Pub. Date: Oct. 23, 2003

(54) Communication device using improved secret key updating method

(75) Inventors: Hiroyuki Aizu, Yokohama-shi (JP); Takaharu Yamamoto, Tokyo (JP); Takeshi Saito, Tokyo (JP); Keiichi Teramoto, Kawasaki-shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: KABUSHIKI KAISHA TOSHIBA, Tokyo (JP)

(21) Appl. No.: 10/417,170

(22) Filed: Apr. 17, 2003

(30) Foreign Application Priority Data
Apr. 17, 2002 (JP) 2002-114185
Apr. 10, 2003 (JP) 2003-106772

(51) Int. Cl. H04L 9/00

(52) U.S. Cl. 380/277

(57) ABSTRACT

A communication device that stores a secret key to be used in an authentication and an encryption of communication information with respect to a specific communication device, and carries out communications with the specific communication device, by using the stored secret key to be used with respect to the specific communication device, is equipped with a unit for updating a specific secret key, when an update request received from another communication device is requesting a secret key updating, according to an update content given along with the update request which indicates the specific secret key.

### BACKGROUND OF THE INVENTION

1. Field of the Invention

The present invention relates to a communication device, a communication method and a communication program for carrying out communications using a secret key, and more particularly to the updating of a secret key information maintained by a communication device.

2. Description of the Related Art

In recent years, in conjunction with the widespread use of electronics in electric products and the advances of the Internet, it has become possible to connect all kinds of the home appliances to the Internet. By connecting the home appliances to the Internet, there are possibilities for creating new way of using the home appliances.

A network formed by the conventional home appliances products is referred to as a home network. In order to form the home network by the conventional home appliances, it is possible to consider the application of the radio technology. The radio network does not require any new communication cables, and the devices can be moved easily.

However, the radio network has a drawback that the eavesdropping is relatively easy. For example, it is possible to make a connection to the radio network inside the home from an outdoor or a neighboring home through walls, and cause the operation error or do some mischievous thing. For this reason, the radio network is used along with the security function.

The security function uses many so called “identity pass” such as a password and a PIN (Personal Identification Number) code. That is, the user is urged to input the “identity pass” that can be known only by a specific user, and only when it is authenticated this user is permitted to become a corespondent. In this way it is possible to guarantee that information exchanges are carried out only among the permitted users. In addition, by encrypting the communication contents themselves by using the “identity passes”, it becomes possible to prevent the leakage of information even if a person intending to steal information somehow manages to eavesdrop the communications.

The above described “identity pass” can be expected to have a higher security level by making it more complicated. For example, for the “identity pass” with one character (8 bits) and the “identity pass” with two characters (16 bits), the straightforward calculation shows that the number of patterns that can possibly be taken is 256 and 65536, respectively. It is apparent that the “identity pass” with two characters can possibly take far more complicated patterns. In this way, when the number of characters is increased, the danger for having the “identity pass” exposed is reduced and the security level of the system security is raised considerably.

However, many home appliance products are currently not equipped with a mechanism for inputting the “identity pass” that is sufficiently complicated to fulfill the need. For example, the home appliance products such as a washer and a refrigerator that are designed for the purpose of relatively simple works do not have many buttons provided thereon so that they are not suitable for inputting the “identity pass”.

It is possible to equip these products with an equipment such as a keyboard solely for the purpose of inputting the above described “identity pass”. However, considering the general utilization environment, the often adopted utilization form is that the “identity pass” input is made only at a time of using that product for the first time and thereafter only information after the authentication is maintained inside the home appliance product so that there is no need to input the “identity pass” again. In such a utilization form, the frequency of using the keyboard is extremely low compared with the frequency of using the keyboard under the situation in which the keyboard is originally designed to be used such as that of a computer. Consequently, it is preferable to eliminate such an equipment as much as possible.

There is also a proposition of a method for inputting by using something other than the keyboard, such as a selector, for example (Japanese Patent Application Laid Open No. 2001-298531). However, this method has a drawback in that the characters that can be used will be limited to those that can be selected by the selector. This in turn requires considerable time and effort in order to input a long and complicated “identity pass”. In any case, this method requires to provide a selector, and this in turn significantly affects the design of the product itself.

Despite of the reality faced by the home appliance products as described above, in the case of the home appliance products, it must be an input device by which anyone can easily enter the “identity pass” (such as a free keyword with over ten characters) which is sufficiently complicated to guarantee the sufficient security level for the system security. As long as the input device that satisfies the above described condition is to be provided, it is likely to cause the increase in the product cost or a problem regarding the product design.

### BRIEF SUMMARY OF THE INVENTION

It is therefore an object of the present invention to provide a scheme for easily enabling the updating of the secret key that serves as an identity pass required for the authentication or the concealment of the communication information by encrypting the communication contents, which is maintained by the communication device connected a network such as a home appliance product.

According to one aspect of the present invention there is provided a communication device, comprising: a secret key storing unit configured to store a secret key to be used in an authentication and an encryption of communication information with respect to a specific communication device; a communication unit configured to carry out communications with the specific communication device, by using the secret key to be used with respect to the specific communication device stored in the secret key storing unit; and a secret key updating unit configured to update a specific secret key in the secret key storing unit, when an update request received from another communication device is requesting a secret key updating, according to an update content given along with the update request which indicates the specific secret key.

According to another aspect of the present invention there is provided a communication method at a communication device, comprising: storing a secret key to be used in an authentication and an encryption of communication information with respect to a specific communication device, in a memory of the communication device; carrying out communications with the specific communication device, by using the secret key to be used with respect to the specific communication device stored in the memory; and updating a specific secret key in the memory, when an update request received from another communication device is requesting a secret key updating, according to an update content given along with the update request which indicates the specific secret key.

According to another aspect of the present invention there is provided a computer program product for causing a computer to function as a communication device, the computer program product comprising: a first computer program code for causing the computer to store a secret key to be used in an authentication and an encryption of communication information with respect to a specific communication device, in a memory of the communication device; a second computer program code for causing the computer to carry out communications with the specific communication device, by using the secret key to be used with respect to the specific communication device stored in the memory; and a third computer program code for causing the computer to update a specific secret key in the memory, when an update request received from another communication device is requesting a secret key updating, according to an update content given along with the update request which indicates the specific secret key.

Other features and advantages of the present invention will become apparent from the following description taken in conjunction with the accompanying drawings.

### BRIEF DESCRIPTION OF THE DRAWINGS

FIG. 1 is a schematic diagram showing an exemplary overall system configuration according to one embodiment of the present invention.

FIG. 2 is a block diagram showing one exemplary internal configuration of a home appliance according to one embodiment of the present invention.

FIG. 3 is a diagram showing an exemplary way of generating a link key from a PIN code and a random number in the home appliance of FIG. 2.

FIG. 4 is a block diagram showing another exemplary internal configuration of a home appliance according to one embodiment of the present invention.

FIG. 5 is a block diagram showing an exemplary internal configuration of an access point according to one embodiment of the present invention.

FIG. 6 is a block diagram showing an exemplary internal configuration of a controller according to one embodiment of the present invention.

FIG. 7 is a flow chart showing an exemplary flow of a reset operation by the home appliance according to one embodiment of the present invention.

FIG. 8 is a sequence chart showing a first half of an exemplary operation flow among communication devices according to one embodiment of the present invention.

FIG. 9 is a sequence chart showing a second half of an exemplary operation flow among communication devices according to one embodiment of the present invention.

### DETAILED DESCRIPTION OF THE INVENTION

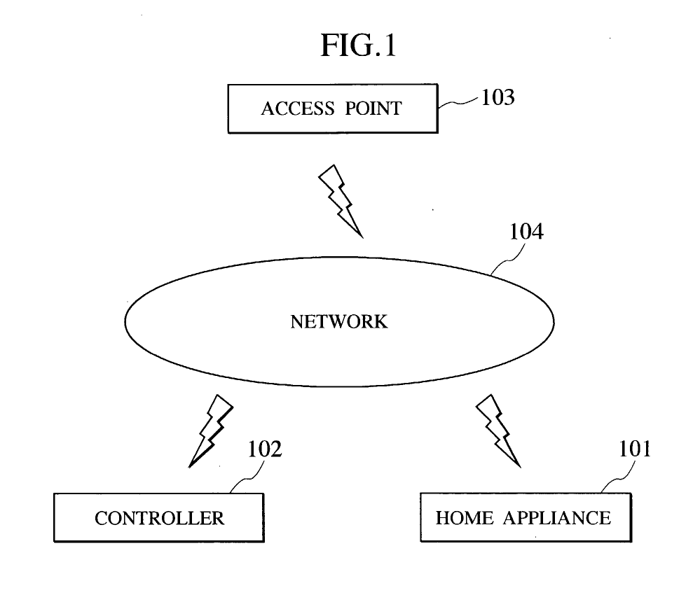

Referring now to FIG. 1 to FIG. 9, one embodiment of the present invention will be described in detail.

FIG. 1 shows an overall system configuration in one embodiment of the present invention, which comprises a network 104 to which a home appliance 101, a controller 102 and an access point 103 are connected. The home appliance 101 is a communication device which carries out communications with the access point 1-3 connected to the network 104 under the ordinary utilization state after the initial setting. The access point 103 relays communications from the home appliance 101 to a network or host not shown in the figure but connected to the access point 103. Also, the access point 103 itself functions as an application server that carries out information processing along with the home appliance 101. The controller 102 is a communication device to be used in making a setting of a secret key, etc., by carrying out communications with the home appliance 101 when the home appliance 101 is in the initial state immediately after the purchase, or when the home appliance 101 is reset to the initial state.

As already mentioned above, it is expected that a stronger security can be realized with the character string that constitutes the secret key which is more complicated and conveying a larger amount of information.

However, the home appliance 101 is often not equipped with a sufficient mechanism for directly inputting the character string that constitutes the secret key manually such as a keyboard. It is not impossible to implement a mechanism for inputting the character string which is more complicated and conveying a large amount of information on any device, but the input operation to be carried out by such a mechanism is far from easy. In addition, there can be cases where a plurality of such secret keys are to be set, or the already set secret key is to be corrected, and this can be an extremely tedious operation. In addition, this tendency becomes even stronger when the fact that users who handles the home appliance may include housewives, aged persons and children who are not expected to have much skills in the device operation is taken into consideration.

On the other hand, the controller 102 is equipped with a mechanism for inputting the above described character string such as a keyboard. The input characters can be directly inputted at the input device such as a keyboard. It is also possible to implement a guidance function so as to guide the updating procedure, thereby improving the convenience of the user who uses it. In addition, the secret information that is set once in the home appliance 101 through the controller 102 can be maintained inside the controller 102. In this way, even when all the secret keys maintained at the home appliance 101 are lost due to the accidental power supply trouble or the like, there is no need for the user to input the character strings that constitute the secret keys again at the keyboard of the controller 102. Using the secret key information maintained at the controller 102, it is possible to recover the home appliance 101 immediately, or account for the secret key information at the home appliance 101.

In this embodiment, the radio network that constitutes the network 104 is assumed to be the Bluetooth (registered trademark). The Bluetooth (registered trademark) is the radio communication technology for portable information devices which are promoted mainly by five companies including the Ericsson, IBM, Intel, Nokia, and Toshiba. Unlike the one that utilizes the infrared rays, the Bluetooth (registered trademark) can be utilized even when there is an obstacle, as long as a distance between devices is within 10 m. Also, a compact transceiver of 0.5 square inch is utilized for communications so that the power consumption is suppressed low, and it is suitable for implementation into the home appliance. The radio technology for realizing the present invention is not limited to the case of this embodiment, and it can be replaced by a different network utilizing radio or a wired network.

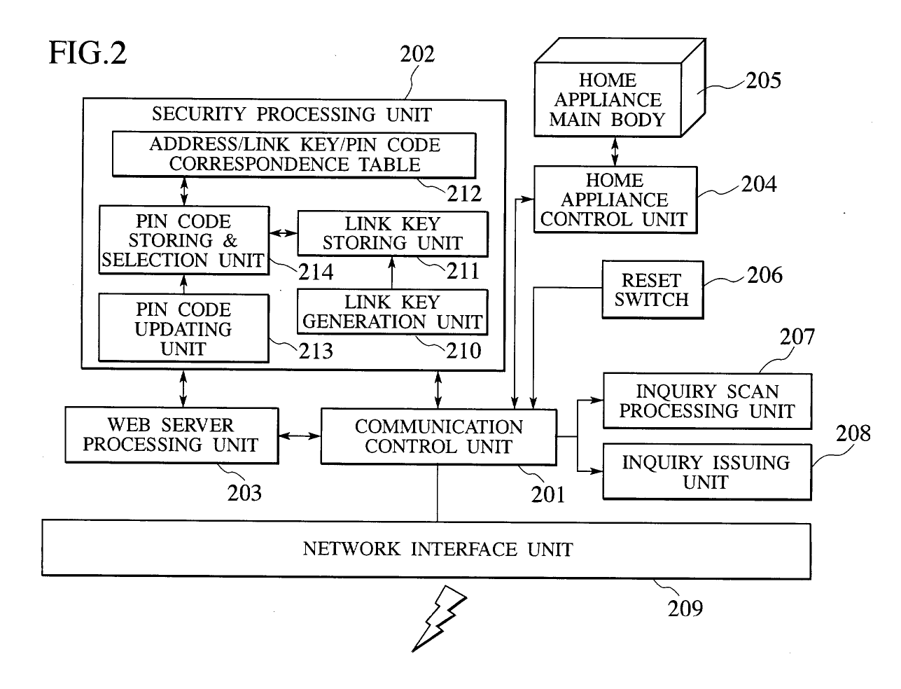

Next, FIG. 2 shows an exemplary internal configuration of the home appliance 101, which comprises a communication control unit 21 surrounded by a security processing unit 202, a web server processing unit 203, a home appliance control unit 204, a reset switch 206, an inquiry scan processing unit 207, an inquiry issuing unit 208, and a network interface unit 209.

The communication control unit 201 establishes communications with a correspondent on the network, by exchanging connection requests by using the inquiry scan processing unit 207 and the inquiry issuing unit 208. Here, the correspondent is the access point 103 or the controller 102 shown in FIG. 1. Besides that, the communication control unit 201 also makes changes of various settings inside the home appliance 101.

The security processing unit 202 manages the secret key to be used in carrying out communications with the correspondent. The security processing unit 202 internally has a link key generation unit 210, a link key storing unit 211, an address/link key/PIN code correspondence table 212, a PIN code updating unit 213, and a PIN code storing and selection unit 214. The PIN code is a code indicating a Personal Identification Number.

The web server processing unit 203 provides an interface for updating the PIN code or the link key stored by the security processing unit 202. In this embodiment, one of the web server functions called CGI (Common Gateway Interface) is used in order to change these values from an external. The web server processing unit 203 provides an interface based on the web page with respect to an external communication device.

The home appliance control unit 204 controls the home appliance main body 205, or collects an operation state from the home appliance main body 205 and carries out the information transmission through the communication control unit 201. The home appliance main body 205 in this case can be a home appliance product such as a refrigerator, a washer, a microwave oven, etc.

The reset switch 206 is used at a time of resetting the device into the initial state. In the general utilization environment, the home appliance is scarcely reset, but in the TV or the like, when it stops displaying properly or it becomes impossible to change the receiving channel, the reset is made as a last resort. There are some home electronic products which have no reset switch because of its low utilization frequency. There are also many home appliance in which the plugging in or out of a power supply cord or setting in or pulling out of an internal battery as a substitution of the reset switch.

Usually, the home appliance product has many setting values according to the initial setting and the utilization states. In the general utilization state, the setting values that are set once should preferably be not deleted very often. Once they are deleted, the operation for setting them again can be difficult when there are many setting items. For this reason, the preferable reset operation is one that can be carried out in stages, such as the light reset is carried out first, and only when it still does not recover, the overall reset is carried out. For example, the home appliance main body 205 is reset when the home appliance main body 205 stops responding, and the entire device including the communication control unit 201 is reset when the communications through the network interface 209 become impossible. This is because when the entire device including the communication control unit 201 is reset, the information regarding the communications such as the PIN code may be lost such that it becomes totally impossible to carry out the communications.

The selective use of the different reset operations as described above can be judged according to a length of the period of time for which the reset switch is pressed by the operator. In the earlier example, only the home appliance main body 205 is reset when the reset switch is pressed only for one second, and the entire device including the communication control unit 201 is reset when the reset switch is pressed for a longer period of time than that. In this way, a plurality of functions can be realized by a single switch, so that there is no need to increase the number of switches unnecessarily, which is advantageous from viewpoints of the cost and the design. The reset switch described here is not necessarily limited to a switch like a button switch, and can be substituted by the plugging in or out of the power supply cord mentioned above, for example.

Next, the internal configuration of the security processing unit 202 will be described.

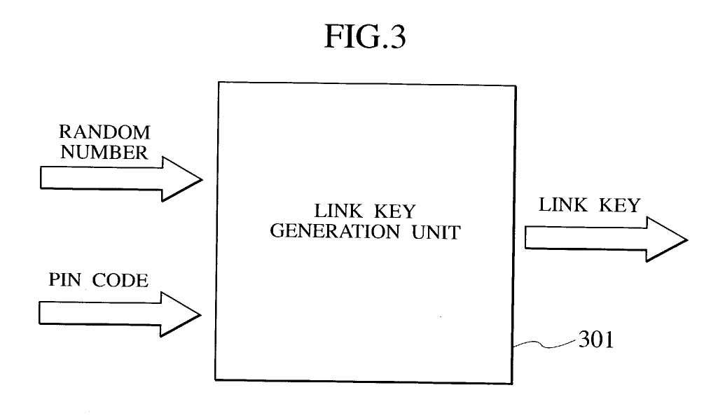

First, the link key will be described. In the Bluetooth (registered trademark), the link key to be used in the communications is generated as shown in FIG. 3. Namely, the link key is generated by inputting a random number generated according to a generation time or other random number, and the PIN code into the link key generation unit 301.

The random number is a value that becomes a seed of the link key. After it is generated by an appropriate method at one communication device, it is notified to the other communication device according to the Bluetooth (registered trademark) specification, so as to be shared by both sides.

The PIN code is a value of 16 octets (128 bits) at the maximum, and its length can be freely chosen within that range. When the PIN code is shorter than the maximum length, it is customary to complement the PIN code with some fixed value such as an address value so as to realize the length of 16 octets in view of the security strength. The PIN code length described here is one that specified in the above described communication specification, and in the case of using a different specification in which the even longer PIN code is permitted, it is possible to use the even longer PIN code.

The PIN code must be shared between both communication devices which carry out communications, but unlike the random value described above, it is not notified to the correspondent by the communications. Consequently, in order to carry out communications between the communication devices, there is a need to share the PIN code by exchanging it by some other method with a high secrecy before the communications. In the initial stage of the communications, the correspondent is recognized as proper when the same PIN code is shared. The secrecy of the PIN code cannot be guaranteed if the open network such as the radio network-is used for the exchange of the PIN code. In order to guarantee the secrecy, a simple method in which the operator enters the PIN code by operating the keyboard or the like has been employed conventionally.

The link keys generated at the both communication devices according to the random number and the PIN code that are shared will have the identical value, so that the authentication and the encryption/decryption of information are carried out by using the link key as a key. In other words, the communications cannot be established if the PIN codes are different. In this way, it becomes possible to establish communications only between the communication devices that share the PIN code, as long as the PIN code is kept secret.

The communication control unit 201 cooperates with the web server processing unit 203 to acquire an update information for the PIN code. Here, the update information is an information for addition, deletion, or change of the PIN code stored by this communication device, for example. Besides that, it is possible to use the update information for any information stored by this communication device, such as information stored in relation to that PIN code which can include a link key generated from the PIN code, or an address and a node name of the correspondent communication device that shares this PIN code, etc.

The acquired update information is given to the PIN code updating unit 213 through the CGI. The PIN code updating unit 213 that received the update information controls the link key generation unit 210 to generate the link key according to that PIN code, and gives the PIN code to the PIN code storing and selection unit 214. The link key generated by the link key generation unit 210 is stored by the link key storing unit 211. Also, this value is stored into the address/link key/PIN code correspondence table 212 in correspondence to the address, by the PIN code storing and selection unit 214. Here, the address is a physical address assigned to the network interface. This address value is assigned uniquely to the network interface, so that it can be utilized as an identifier of the communication device.

The address/link key/PIN code correspondence table 211 stores the link key and the PIN code in correspondence to the address. In this way, in the case of carrying out communications with the connection target communication device represented by the address, the link key corresponding to that address can be obtained immediately. The obtained link key is stored in the link key storing unit 211, and utilizes as the key information in the communications with that communication device.

According to the Bluetooth (registered trademark) specification, the different PIN codes can be allocated to different connection target devices. Using the mechanism described above, it becomes possible to carry out communications based on different PIN codes with a plurality of correspondents.

Also, when the PIN code and the link key are lost due to the reset of the home appliance 101 described above or when the home appliance 101 is immediately after its purchase, it is possible to set a prescribed PIN code automatically and carry out communications by utilizing that PIN code. Using this PIN code as the shared key on both sides, it becomes possible to carry out the authentication and the encrypted communications according to this PIN code even before the formal PIN code is set by the controller 102. The formal PIN code set by the controller is the PIN code possessed by the access point 103 which is a normally intended correspondent of the home appliance 101. This PIN code is apparently information to be kept secret so that the encryption should be applied to this PIN code.

As described above, the PIN code updating unit 213 is provided to enable the updating of the PIN code through the network from the controller 102 which has the input method suitable for the PIN code updating operation. In this way, the PIN code updating becomes considerably easier than the case of carrying that out by directly operating the home appliance 101. In addition, the input device such as a keyboard becomes unnecessary at the home appliance 101, so that it becomes possible to suppress the manufacturing cost and provide the home appliance without a feature that can potentially damage the design of the product itself.

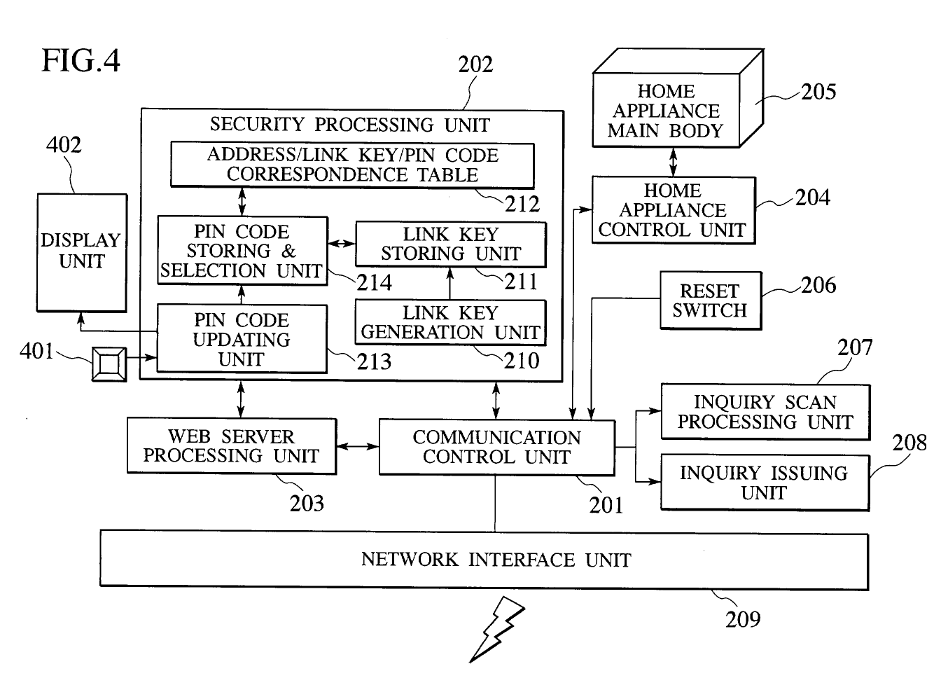

Here, as shown in FIG. 4, it is also possible to equip the PIN code updating unit 213 with a simple input device formed by one, two or three buttons 401, and a simple display unit 402 such as a liquid crystal display device. In this way, the fact that the updating is commanded for the acquired update information can be displayed on the display device in order to check whether the updating is permitted or not in advance, simple command for commanding the updating or a part of commands regarding the update processing such as start and end of the update processing can be given from the communication device. Also, the buttons 401 and the display unit 402 can be considerably compact and cheap compared with the input and output devices suitable for updating the PIN code freely such as a keyboard and a CRT of a PC, for example, so that these devices are unlikely to significantly affect the product design and the manufacturing cost.

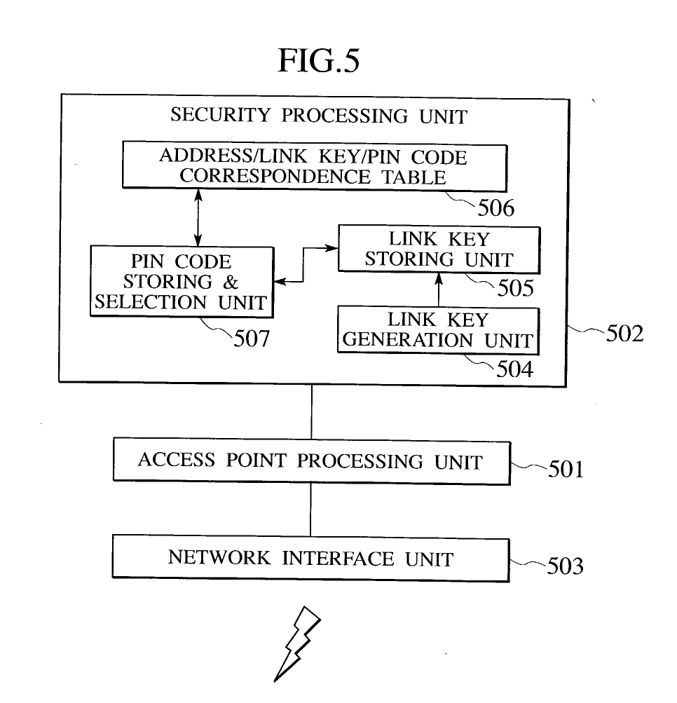

Next, FIG. 5 shows an exemplary communication portion in an internal configuration of the access point 103 that becomes the correspondent of the home appliance 101. The access point 103 has a function for transferring the communication data received from the home appliance 101 through the network 104 to a different network. This function regarding the transfer is carried out by an access point processing unit 501.

The access point 103 carries out the authentication and the encrypted communications with a plurality of communication devices, similarly as the home appliance 101. For this purpose, a security processing unit 502 has a link key generation unit 504, a link key storing unit 505, a PIN code storing and selection unit 507, and an address/link key/PIN code correspondence table 506. With this configuration, it becomes possible to selectively use the link key and the PIN code according to the correspondent at the access point 103 as well.

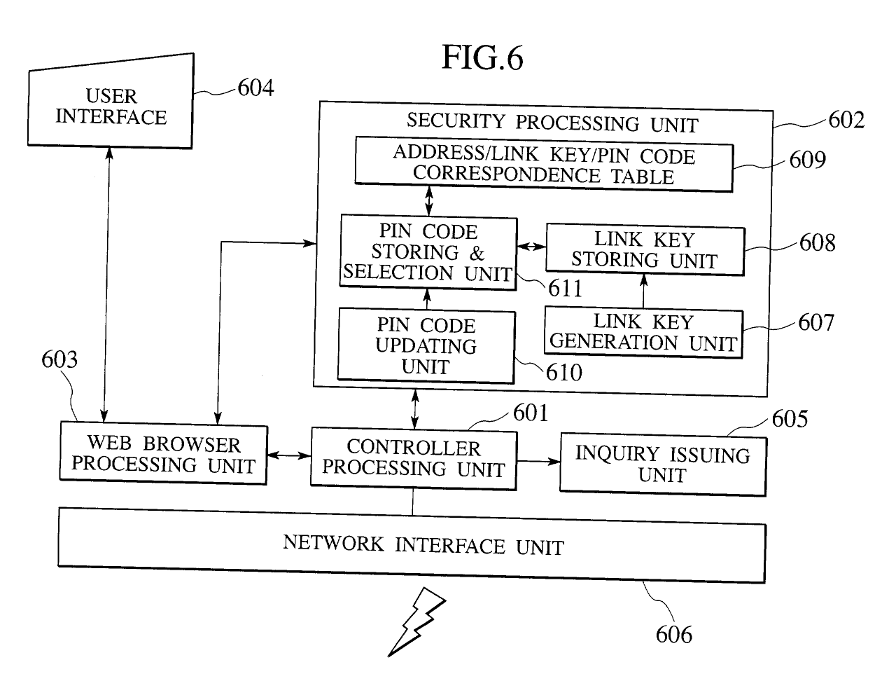

Next, the controller 102 will be described. FIG. 6 shows an exemplary internal configuration of the controller 102, which comprises a controller processing unit 601, surrounded by a security processing unit 602, a web browser processing unit 603, a user interface 604, an inquiry issuing unit 605, and a network interface 606.

The controller processing unit 501 controls the inquiry issuing unit 605 to issue a communication establishing request to the home appliance 101 on the network. At this point, the home appliance 101 in the initial state is carrying out the inquiry scan, and accepts the communication establishing request resulting from that inquiry.

The security processing unit 602 is provided for managing the secret key to be used in carrying out the encrypted communications with the correspondent. The security processing unit 602 internally has a link key generation unit 607, a link key storing unit 608, an address/link key/PIN code correspondence table 609, a PIN code updating unit 610, and a PIN code storing and selection unit 611. The PIN code is a code indicating a Personal Identification Number.

In addition, the web browser processing unit 603 having a web browser function is provided for the purpose of the updating operation of the PIN code maintained by the home appliance 101. The web browser processing unit 603 cooperates with the security processing unit 602 to obtain an information regarding the PIN code maintained by the home appliance 101. For example, this information contains a value of the PIN code maintained at the home appliance 101 at the previous time, a list of selectable PIN code values, etc. The home appliance 101 has the web server function, and the web page provided by that web server can be displayed at the user interface 604 by the web browser processing unit 603. The user interface 604 has a flexible information input device such as full scale keyboard, for example. The operator operates this user interface 604, and updates the PIN code maintained by the home appliance 101 through the web page displayed by the web browser processing unit 603.

Next, the internal configuration of the security processing unit 602 will be described.

In order to start communication with the home appliance 101 that has any PIN code and becomes the correspondent, there is a need to change the PIN code possessed by the controller 102, and the PIN code updating unit 610 is provided for this purpose. The PIN code updating unit 610 may be operated through the user interface 604, or by some other method.

From the PIN code updated as described above, a link key is generated by the link key generation unit 607 at appropriate timing. Then, the link key is set in correspondence to the PIN code and the address by the PIN code storing and selection unit 214, and stored into the address/link key/PIN code correspondence table 609. Here, the address is a physical address assigned to the network interface.

The address/link key/PIN code correspondence table 609 stores the link key and the PIN code in correspondence to the address. In this way, in the case of carrying out communications with the connection target communication device represented by the address, the link key corresponding to that address can be obtained immediately. The obtained link key is stored in the link key storing unit 608, and utilizes as the key information in the communications with that communication device.

According to the Bluetooth (registered trademark) specification, the different PIN codes can be allocated to different connection target devices. Using the mechanism described above, it becomes possible to carry out communications based on different PIN codes with a plurality of correspondents.

In addition, the address/link key/PIN code correspondence table 609 stores information on the PIN code to be set to the home appliance 101, besides the PIN code to be used for communications by the controller 102 itself. This is the PIN code to be used when the home appliance 101 carries out communications with the access point 103. As already described above, this PIN code is read out by the web browser processing unit 603, and accounted in the PIN code maintained by the home appliance 101.

As described above, the controller 102 maintains the PIN code that should be maintained by the setting target home appliance 101 in order to carry out communications with the other communication devices, and has a function for updating the PIN code maintained by the home appliance in cooperation with the updating function of the PIN code updating unit 213 of the home appliance 101. Here, the controller 102 is equipped with the input mechanism suitable for the updating of the secret key, so that the tedious updating operation of the secret key can be carried out easily. In addition, the input device such as a keyboard becomes unnecessary at the home appliance 101, so that it becomes possible to suppress the manufacturing cost and provide the home appliance without a feature that can potentially damage the design of the product itself.

Next, the operation flow of the communication device in one embodiment of the present invention will be described.

As already described, there can be cases where it is desirable to selectively use the stages of the reset of the home appliance 101, in order to keep the current setting value as much as possible. However, providing different reset switches for different reset stages is disadvantageous from viewpoints of the cost and the design. What is described in the following is for the purpose of accurately carrying out the reset operations of a plurality of stages by using a single reset switch.

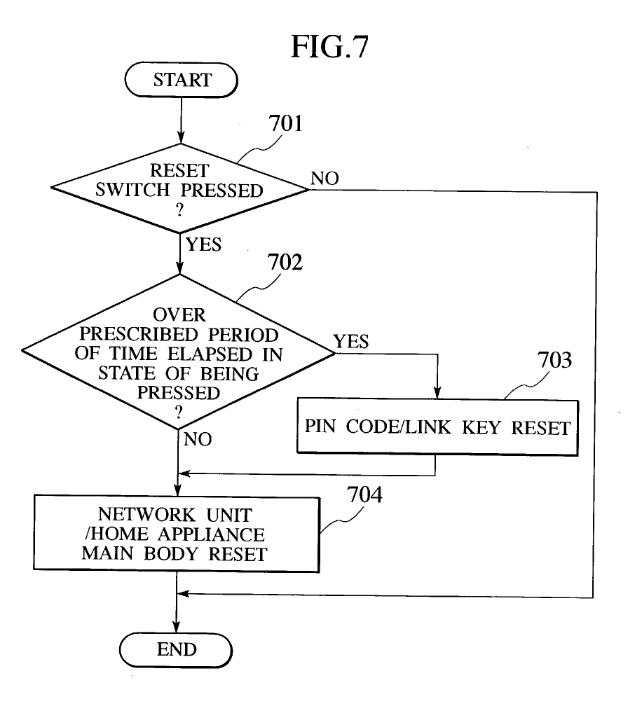

FIG. 7 shows an exemplary flow for the operation according to the period of time by which the reset switch 206 provided at the home appliance 101 is pressed. At the step 701, whether the reset switch 206 is pressed or not is checked. If it is confirmed as pressed, how long the pressed state continues is checked.

At the step 702, if it is detected that the reset switch 206 has been continually pressed for a prescribed period of time, such as five seconds, for example, the reset of the PIN code/link key is carried out at the step 703. In this step, the maintained PIN code and link key are deleted, and the PIN code originally given as the initial value is set as the PIN code after the reset. Then, at the step 704, the reset of the communication control unit 201 and the home appliance main body 205 is carried out to recover the initial state.

After that, the home appliance that is set in the initial state establishes communications with the controller 102, and the PIN code necessary for communications with the access point 103 is given by the controller 102.

At the step 702, if it is confirmed that the reset switch 206 is released within the prescribed period of time, such as one second later, for example, only the step 704 is executed. In this case, the previous values of the PIN code and the link key are maintained, so that the communications with the access point 103 can be continued. This is used in the case of the reset of a relatively light trouble, such as a trouble occurred in the home appliance main body 205 or a trouble that the communication unit does not respond.

By setting an appropriate reset switch continuously pressing period of time for executing the step 703 by accounting for the device utilization state, it is possible to provide a plurality of reset stages by using a single reset switch. In this way, there is no need to increase the number of switches unnecessarily, which is advantageous from viewpoints of the cost and the design.

In addition, by setting a prescribed PIN code after the reset operation of the PIN code and the link key, it is possible to carry out the formal PIN code setting operation by the home appliance after the reset, by communications using the secret key.

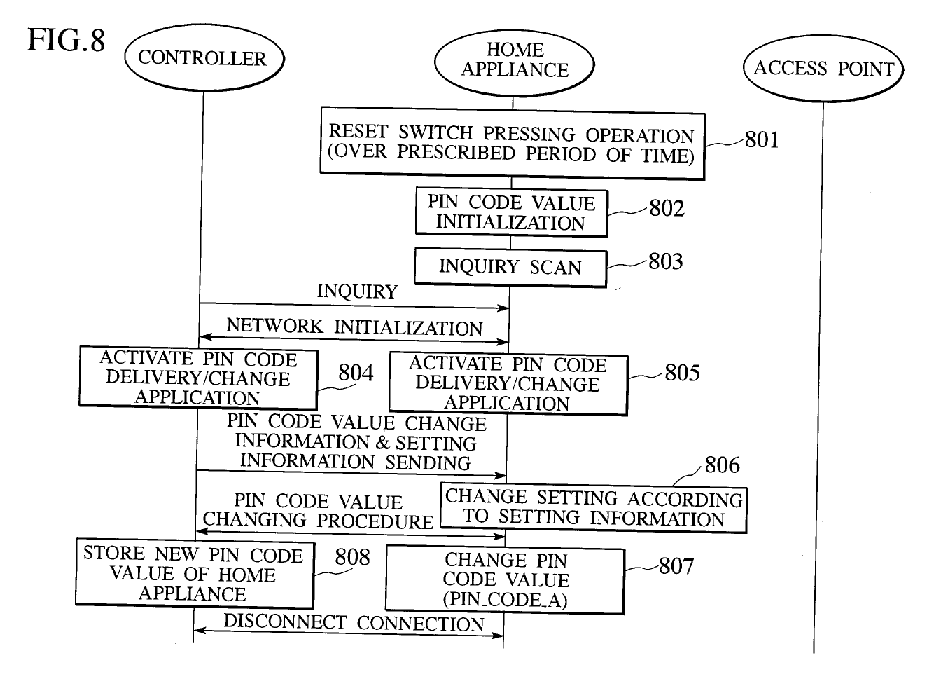

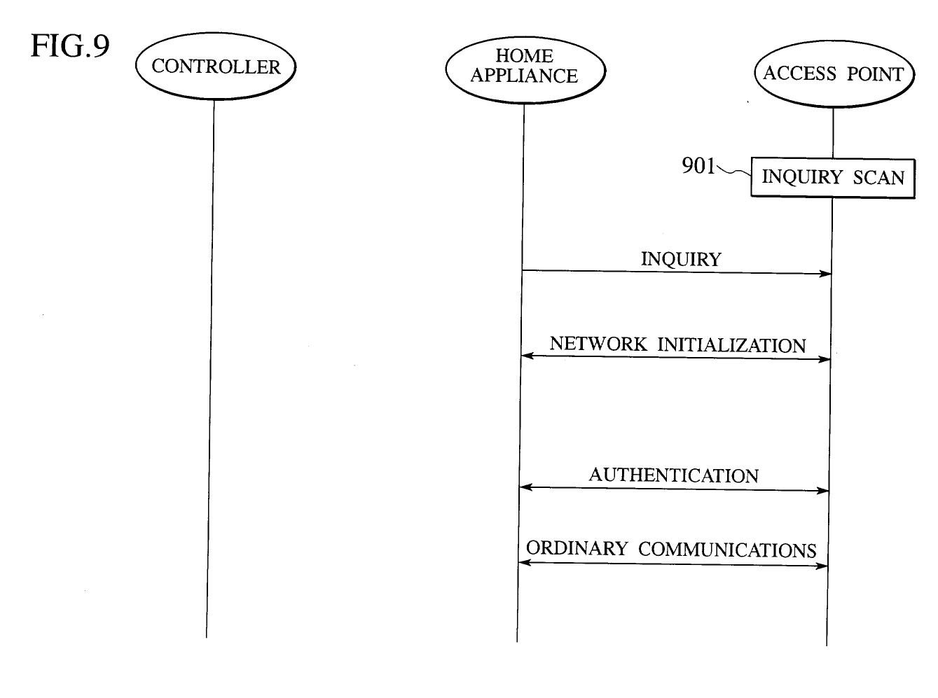

Next, FIG. 8 and FIG. 9 shows an exemplary flow of the operation by which the home appliance 101 carries out communications with the controller 102 and establishes communications with the access point 103. FIG. 8 shows a part of the operation up to a point where the home appliance 101 obtains the formal PIN code from the controller 102, and FIG. 9 shows a remaining part of the operation.

First, at the step 801 of FIG. 8, suppose that the reset switch is pressed over a prescribed period of time and the total reset of the home appliance 101 is carried out. By the total reset, all the PIN codes and the link keys maintained by the home appliance 101 are deleted. Next, at the step 802, the PIN code given to the home appliance 101 in advance is set as the PIN code of the home appliance 101. This PIN code will be denoted as PIN₁₃ CODE₁₃ B.

It is assumed that the access point 103 existing in the same network which is the actual correspondent of the home appliance 101 has PIN₁₃ CODE₁₃ A as its PIN code. At this stage, the PIN codes of the home appliance 101 and the access point 103 are different so that communications between them will not be established.

In order to carry out communications with the access point 103, there is a need to update the PIN code possessed by the home appliance 101. However, the home appliance 101 does not have an interface for input such as a keyboard. Hence there is a need for a stage in which the home appliance 101 secures a connection with the controller 102 first and receives the appropriate PIN code provided from the controller 102.

The home appliance 101 carries out the inquiry scan at the step 803. This inquiry scan checks presence/absence of the communication device that is issuing the connection request (inquiry) to the network. This is the operation that should be carried out by a communication device having a server like function such as the access point 103 rather than a terminal device such as the home appliance 101. After the initialization, the home appliance 101 itself cannot establish communications with the other communication device because it has not obtained the formal PIN code. Hence the home appliance 101 here tries to detect the communication device that rather requests a connection to it, by carrying out the inquiry scan.

The controller 102 attempts to establish communications with the home appliance 101 that is carrying out the inquiry scan, by using the initial value (PIN₁₃ CODE₁₃ B) of the PIN code of the home appliance 101 that is known in advance. At this point, the controller 102 issues an inquiry by specifying the home appliance 101 as the correspondent. This inquiry is captured by the home appliance 101, and the communications between them are established as the PIN codes of the home appliance 101 and the controller 102 are identical.

After that, the delivery of the formal PIN code is carried out. At the home appliance 101 side, a PIN code delivery/change application is activated (step 805), and at the controller 102 side, the PIN code delivery/change application to be operated in cooperation with that of the home appliance 101 side is activated (step 804). For example, the application activated on the home appliance 101 side can be a web server that provides CGI, and the application activated on the controller 102 side can be a web browser.

The exchanges between the home appliance 101 and the controller 102 are carried out and eventually the PIN code value change information is sent to the home appliance, along with a setting information for making various settings of the home appliance 101 if necessary. Next, the PIN code maintained by the home appliance 101 is updated by the PIN code value change information. By this operation, the home appliance 101 obtains the PIN code (PIN₁₃ CODE₁₃ A) necessary for communications with the access point 103 from the controller 102, and stores it into a storing region. The home appliance 101 changes the own PIN code to that obtained PIN code (step 807) and then releases the connection with the controller 102.

At this point, the controller 102 records the fact that the current PIN code of the home appliance 101 is changed to PIN₁₃ CODE₁₃ A in a correspondence table stored at the controller 102 (step 808).

When some setting information is contained in the PIN code value change information, the communication control unit 201 makes the setting of the home appliance 101 according to this setting information (step 806). Here, the setting can be a setting of communication parameters when the home appliance 101 carries out communications through the network or a setting regarding which access point should be utilized in the case where a plurality of access points 103 exist, for example.

Next, the home appliance 101 that obtained the formal PIN code attempts a connection with the access point 103, according to FIG. 9 as follows.

The access point 103 is regularly carrying out the inquiry scan (step 901). At this point, the home appliance 101 issues an inquiry with respect to the access point 103 by using the current PIN code (PIN₁₃ CODE₁₃ A), Upon detecting this inquiry, the access point 103 checks whether the own PIN code (PIN₁₃ CODE₁₃ A) and the PIN code of the home appliance 101 are identical or not by carrying out the authentication. At this point the PIN codes of both are identical, so that the communications between them are established.

In this way, by providing the input mechanism suitable for the updating of the PIN code possessed by the home appliance 101 (secret key) at the controller 102 on the network, it becomes possible to easily carry out the updating operation which can be tedious otherwise. In addition, the input device such as a keyboard becomes unnecessary at the home appliance 101, so that it becomes possible to suppress the manufacturing cost and provide the home appliance without a feature that can potentially damage the design of the product itself.

As described, according to the present invention, it becomes possible to provide a scheme for easily enabling the updating of the secret key that serves as an identity pass required for the authentication or the concealment of the communication information by encrypting the communication contents, which is maintained by the communication device connected a network such as a home appliance product.

As a result, it becomes possible to easily set the secret key that becomes necessary as a sufficiently complicated identity pass in order to authenticate the correspondent or conceal the communication information by encrypting the communication contents, to the communication device (such as the home appliance) which does not have a major input device.

It is to be noted that the above described embodiments according to the present invention may be conveniently implemented using a conventional general purpose digital computer programmed according to the teachings of the present specification, as will be apparent to those skilled in the computer art. Appropriate software coding can readily be prepared by skilled programmers based on the teachings of the present disclosure, as will be apparent to those skilled in the software art.

In particular, the communication device of the above described embodiments can be conveniently implemented in a form of a software package.

Such a software package can be a computer program product which employs a storage medium including stored computer code which is used to program a computer to perform the disclosed function and process of the present invention. The storage medium may include, but is not limited to, any type of conventional floppy disks, optical disks, CD-ROMs, magneto-optical disks, ROMs, RAMs, EPROMs, EEPROMs, magnetic or optical cards, or any other suitable media for storing electronic instructions.

It is also to be noted that, besides those already mentioned above, many modifications and variations of the above embodiments may be made without departing from the novel and advantageous features of the present invention. Accordingly, all such modifications and variations are intended to be included within the scope of the appended claims.

What is claimed is:

1. A communication device, comprising:
a secret key storing unit configured to store a secret key to be used in an authentication and an encryption of communication information with respect to a specific communication device;
a communication unit configured to carry out communications with the specific communication device, by using the secret key to be used with respect to the specific communication device stored in the secret key storing unit; and
a secret key updating unit configured to update a specific secret key in the secret key storing unit, when an update request received from another communication device is requesting a secret key updating, according to an update content given along with the update request which indicates the specific secret key.

2. The communication device of claim 1, wherein the secret key storing unit stores a plurality of secret keys, and
the secret key updating unit adds the specific secret key to the secret key storing unit, when the update request receiving from the another communication device is requesting an addition of a new secret key, according to information of the new secret key to be added given along with the update request which indicates the specific secret key, or deletes the specific secret key among the secret keys stored in the secret key storing unit, when the update request received from the another communication device is requesting a deletion of a part of the secret keys, according to information of the part of the secret keys to be deleted given along with the update request which indicates the specific secret key.

3. The communication device of claim 1, further comprising:
a secret key initial setting unit configured to store a prescribed secret key, and sets the prescribed secret key to the secret key storing unit when all information regarding the secret key stored in the secret key storing unit is lost, such that the communication unit carries out communications with the another communication device by using the prescribed secret key in order to receive information regarding the update request from the another communication device.

4. The communication device of claim 1, wherein the secret key updating unit updates the specific secret key in the secret key storing unit according to the update request from the another communication device, through a common gateway interface.

5. The communication device of claim 1, further comprising at least one of:
an input unit formed by three or less buttons, configured to give commands for a start and an end of a processing, and a confirmation and a selection of information, which is to be used in making an input of information of a part of the commands or a part of the update content that is to be made in a process of updating the specific secret key in the secret key storing unit carried out by the secret key updating unit, is made by using the input unit; and
a display unit capable of simultaneously displaying three or less characters indicating a state of a processing with respect to the commands and the update request.

6. The communication device of claim 1, further comprising:
a setting updating unit configured to update a setting of the communication device according to another request, when the update request received from the another communication device contains the another request for updating the setting of the communication device in addition to a request for the secret key updating.

7. A communication method at a communication device, comprising:
storing a secret key to be used in an authentication and an encryption of communication information with respect to a specific communication device, in a memory of the communication device;
carrying out communications with the specific communication device, by using the secret key to be used with respect to the specific communication device stored in the memory; and
updating a specific secret key in the memory, when an update request received from another communication device is requesting a secret key updating, according to an update content given along with the update request which indicates the specific secret key.

8. The communication method of claim 7, wherein the storing step stores a plurality of secret keys, and
the updating step adds the specific secret key to the memory, when the update request receiving from the another communication device is requesting an addition of a new secret key, according to information of the new secret key to be added given along with the update request which indicates the specific secret key, or deletes the specific secret key among the secret keys stored in the memory, when the update request received from the another communication device is requesting a deletion of a part of the secret keys, according to information of the part of the secret keys to be deleted given along with the update request which indicates the specific secret key.

9. The communication method of claim 7, further comprising:
setting a prescribed secret key to the memory when all information regarding the secret key stored in the memory is lost, such that the carrying out step carries out communications with the another communication device by using the prescribed secret key in order to receive information regarding the update request from the another communication device.

10. The communication method of claim 7, wherein the updating step updates the specific secret key in the memory according to the update request from the another communication device, through a common gateway interface.

11. The communication method of claim 7, further comprising:
updating a setting of the communication device according to another request, when the update request received from the another communication device contains the another request for updating the setting of the communication device in addition to a request for the secret key updating.

12. A computer program product for causing a computer to function as a communication device, the computer program product comprising:
a first computer program code for causing the computer to store a secret key to be used in an authentication and an encryption of communication information with respect to a specific communication device, in a memory of the communication device;
a second computer program code for causing the computer to carry out communications with the specific communication device, by using the secret key to be used with respect to the specific communication device stored in the memory; and
a third computer program code for causing the computer to update a specific secret key in the memory, when an update request received from another communication device is requesting a secret key updating, according to an update content given along with the update request which indicates the specific secret key.

13. The computer program product of claim 12, wherein the first computer program code stores a plurality of secret keys, and
the third computer program code adds the specific secret key to the memory, when the update request receiving from the another communication device is requesting an addition of a new secret key, according to information of the new secret key to be added given along with the update request which indicates the specific secret key, or deletes the specific secret key among the secret keys stored in memory, when the update request received from the another communication device is requesting a deletion of a part of the secret keys, according to information of the part of the secret keys to be deleted given along with the update request which indicates the specific secret key.

14. The computer program product of claim 12, further comprising:
a fourth computer program code for causing the computer to set a prescribed secret key to the memory when all information regarding the secret key stored in the memory is lost, such that the second computer program code carries out communications with the another communication device by using the prescribed secret key in order to receive information regarding the update request from the another communication device.

15. The computer program product of claim 12, wherein the third computer program code updates the specific secret key in the memory according to the update request from the another communication device, through a common gateway interface.

16. The computer program product of claim 12, further comprising:
a fourth computer program code for causing the computer to update a setting of the communication device according to another request, when the update request received from the another communication device contains the another request for updating the setting of the communication device in addition to a request for the secret key updating.
